(19) United States
(12) Patent Application Publication
(10) Pub. No.: US 2005/0192519 A1
(43) Pub. Date: Sep. 1, 2005

(54) Motor assemblies and massage assemblies using the same

(76) Inventor: John Crunick, Cranberry, PA (US)

Correspondence Address: David G. Oberdick;Meyer, Unkovic & Scott LLP, 1300 Oliver Building, Pittsburgh, PA, 15222-2304, US

(21) Appl. No.: 10/788,527

(22) Filed: Feb. 27, 2004

(51) Int. Cl. A61H 1/00

(52) U.S. Cl. 601/72; 601/69; 601/70; 601/80

(57) ABSTRACT

This patent discloses electric motor assemblies for increasing vibratory power with less noise and massage assemblies using the same.

### FIELD OF THE INVENTION

The present invention relates to electric motor assemblies for increasing vibratory power with less noise and massage assemblies using the same.

### BACKGROUND OF THE INVENTION

Numerous massage devices are commercially available to be used by laypersons as well as by trained professionals, such as physical therapists, doctors, and chiropractors. Generally, such devices comprise: (i) an electric motor, (ii) a weight or mass, (iii) a power source, including but not limited to, standard or rechargeable batteries or an AC adaptor, (iv) a treatment head, and (v) a means for holding or manipulating the massager. Many of these massaging devices create a vibratory sensation to stimulate the skin, muscle, body parts, etc. to which they are applied.

Designers, manufactures, consumers, and users of such massage devices often face a trade-off between the power and the noise of the massage devices. Increasing the power or the force of the vibrations of a massage device is often desirable as it produces greater, stronger sensations. Simultaneously, many consumers and users desire to have quiet massage devices. Many massage devices are used to facilitate or induce a feeling of relaxation. Loud noises often counteract such relaxed feelings. Additionally, many consumers and users desire to be able to discretely use massage devices without the attention that noisier devices might attract. Many of the massage devices that are presently on the market suffer from being too noisy and/or from offering too little vibratory power.

One way to increase the power of the massage device or the force of the vibration of a massage device is to increase the weight or mass that is attached to the motor of the massage device. Often such increases in the weight or mass increase the noise emitted by the massage device.

It is an object of the present invention to provide for a motor assembly that decreases the noise associated with many motor assemblies currently on the market. Additionally, it is an object of the present invention to provide for a motor assembly that has greater vibratory power than many of the motor assemblies currently on the market.

Other objects, features, and advantages of the present invention shall be apparent from the figures and description of the invention that follow.

### BRIEF SUMMARY OF THE INVENTION

A preferred embodiment of the present invention encompasses an electric motor assembly for increasing vibratory power with less noise, comprising a motor and a drive shaft having a first end and a second end, wherein the drive shaft runs through the motor and the drive shaft's first end exits on one side of the motor and the drive shaft's second end exits on the opposite side of the motor. A weight, of any mass, is secured to the drive shaft's second end. Finally, a pressure-applying member abuts the drive shaft's first end. The pressure-applying member puts pressure on the drive shaft to stabilize the drive shaft so that the motor assembly produces less noise when the weight rotates. Such a structure allows an increase in the mass of the weight without a significant increase in the noise produced by the motor assembly.

The present invention also encompasses a massage assembly comprising a handle unit and a head unit. A neck connects the handle unit to the head unit. The massage assembly includes a power source. The massage assembly utilizes an electric motor assembly for increasing vibratory power with less noise, which comprises a motor and a drive shaft having a first end and a second end, wherein the drive shaft runs through the motor and the drive shaft's first end exits on one side of the motor and the drive shaft's second end exits on the opposite side of the motor. A weight is secured to the drive shaft's second end. Finally, a pressure-applying member abuts the drive shaft's first end and applies pressure to the drive shaft. The motor assembly provides for a powerful yet quiet massage assembly by utilizing the pressure-applying member to stabilize the drive shaft and to help to counter the increase in the mass of the weight.

A further embodiment of the present invention comprises a massage assembly having a handle unit and a head unit having a face and an attachment side opposite of the face. A neck connects the handle unit to the back of the attachment side of the head unit. This embodiment also comprises a power source. This embodiment of the present invention utilizes an electric motor assembly for increasing vibratory power with less noise, comprising a motor, which may be a DC motor, an AC motor, or another similar type motor. The motor assembly also comprises a drive shaft having a first end and a second end, wherein the drive shaft runs through the motor and the drive shaft's first end exits on one side of the motor and the drive shaft's second end exits on the opposite side of the motor. A weight is secured to the drive shaft's second end. The weight may be an eccentric weight so as to produce vibrations. A pressure-applying member abuts the drive shaft's first end and applies pressure to the drive shaft. The motor assembly is secured within the head unit of the massage assembly.

Finally, another embodiment of the present invention- encompasses a process of decreasing the noise of an electric motor in a vibratory unit by applying pressure to the end of the motor's internal drive shaft.

### BRIEF DESCRIPTION OF THE DRAWINGS

For the present invention to be easily understood and readily practiced, the invention will now be described, for the purposes of illustration and not limitation, in conjunction with the following figures, wherein:

FIG. 1 illustrates a perspective view of one embodiment of a motor assembly according to the present invention;

FIG. 2A is a view from one of the sides of the motor assembly illustrated in FIG. 1;

FIG. 2B is a view of the opposite side of the motor assembly shown in FIG. 2A;

FIG. 3A is a view from one end of the motor assembly of FIG. 1;

FIG. 3B is a view of the opposite end of the motor assembly shown in FIG. 3A;

FIG. 4A shows a top view of the motor assembly of FIG. 1;

FIG. 4B shows a bottom view of the motor assembly of FIGS. 1 and 4A;

FIG. 5 illustrates a perspective view of another embodiment of a motor assembly according to the present invention;

FIG. 6A is a view from one of the sides of the motor assembly illustrated in FIG. 5;

FIG. 6B is a view of the opposite side of the motor assembly shown in FIG. 6A;

FIG. 7A is a view from one end of the motor assembly of FIG. 5;

FIG. 7B is a view of the opposite end of the motor assembly shown in FIG. 7A;

FIG. 8A shows a top view of the motor assembly of FIG. 5;

FIG. 8B shows a bottom view of the motor assembly of FIGS. 5 and 8A;

FIG. 9 is a perspective view of one embodiment of a massage assembly according to the present invention;

FIG. 10 is an exploded view of the massage assembly of FIG. 9;

FIG. 11A is a front, exploded view of the massage assembly of FIG. 9;

FIG. 11B is a back, exploded view of the massage assembly of FIG. 9;

FIG. 11C is a side, exploded view of the massage assembly of FIG. 9;

FIG. 12A is a top view of the massage assembly of FIG. 9;

FIG. 12B is a bottom view of the massage assembly of FIG. 9;

FIG. 12C is a view of the massage assembly of FIG. 12B with the face removed to show one embodiment of a motor assembly inside of the massage assembly;

FIG. 13 is a perspective view of another embodiment of a massage assembly according to the present invention;

FIG. 14 is an exploded view of the massage assembly of FIG. 13;

FIG. 15A is a front, exploded view of the massage assembly of FIG. 13;

FIG. 15B is a back, exploded view of the massage assembly of FIG. 13;

FIG. 15C is a side, exploded view of the massage assembly of FIG. 13;

FIG. 16 is a perspective view of one embodiment of a motor assembly secured to the face of the massage assembly of FIG. 13;

FIG. 17A is a top view of the massage assembly of FIG. 13;

FIG. 17B is a bottom view of the massage assembly of FIG. 13;

FIG. 17C is a view of the massage assembly head of FIG. 17B with the face removed to show one embodiment of a motor assembly inside of the massage assembly;

FIG. 18A illustrates one way of holding a massage assembly according to one embodiment of the present invention; and

FIG. 18B illustrates another way of holding a massage assembly according to one embodiment of the present invention.

### DETAILED DESCRIPTION OF THE PREFERRED EMBODIMENTS

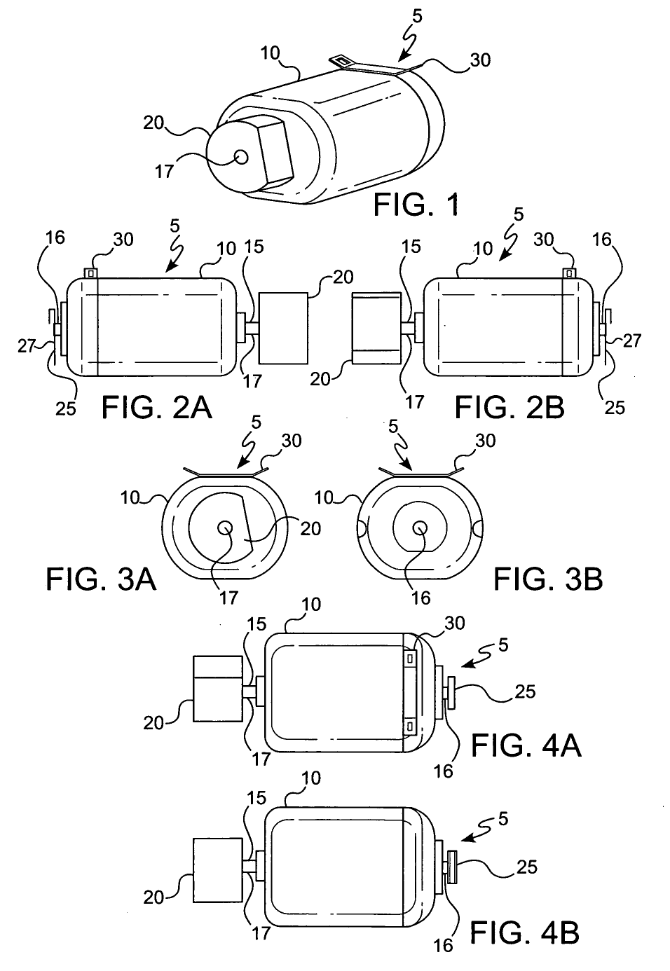

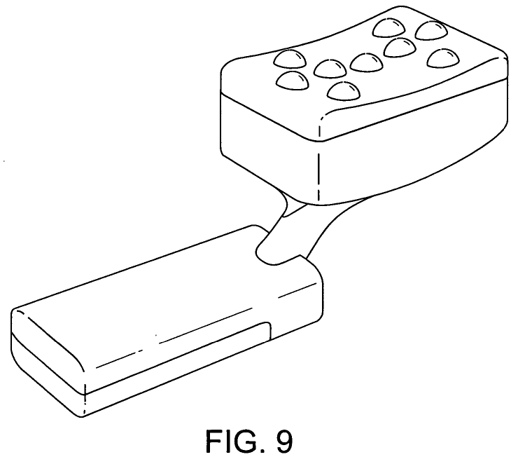

FIGS. 1 through 8B illustrate two preferred embodiments of a motor assembly (5) according to the present invention, each with a different form of a pressure-applying member (25). As shown in FIGS. 1 through 8B, the present invention preferably encompasses a motor assembly (5) comprising a motor (10) and a drive shaft (15) extending through the motor (10). The drive shaft (15) has a first end (16) and a second end (17) (shown best in FIGS. 2A, 2B, 6A, and 6B). The drive shaft's (15) first end (16) exits on one side of the motor (10) and the drive shaft's (15) second end (17) exits on the opposite side of the motor (10). A weight (20), of any mass or size, is secured to the drive shaft's (15) second end (17). Finally, a pressure-applying member (25) abuts the drive shaft's (15) first end (16). The pressure-applying member (25) puts pressure on the drive shaft (15) to stabilize the drive shaft (15) so that the motor assembly (5) produces less noise when the weight (20) rotates. Such an overall design and structure allows an increase in the mass of the weight (20) without a significant increase in the noise produced by the motor assembly (5). Additionally, the motor assembly (5) of the present invention will be powered by a power source, which could be one or more batteries or a power cord to connect the motor assembly (5) to an electrical outlet.

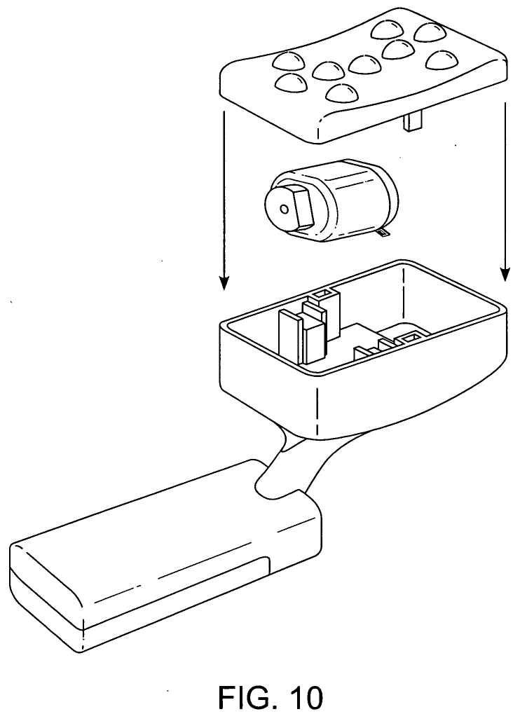

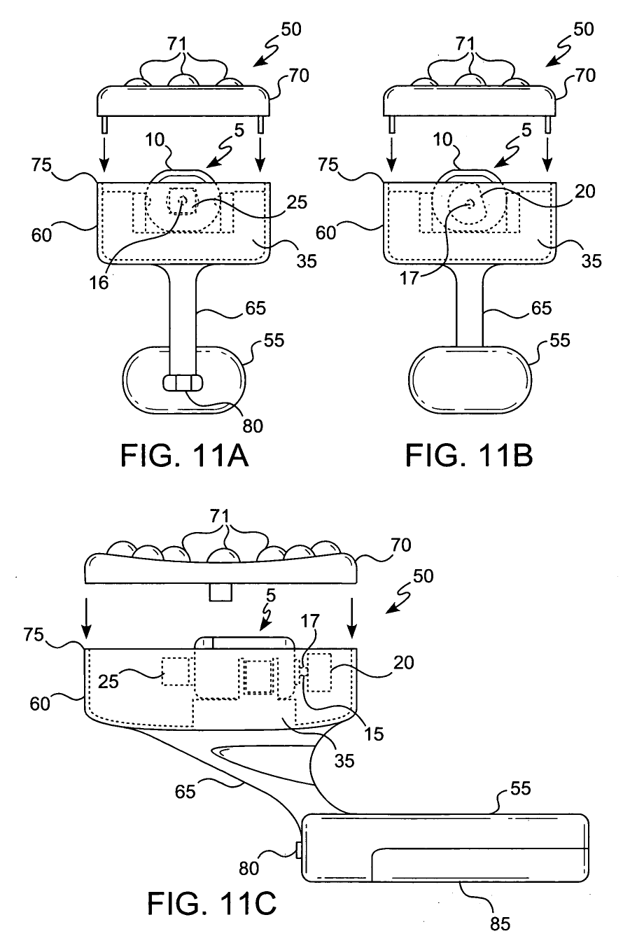

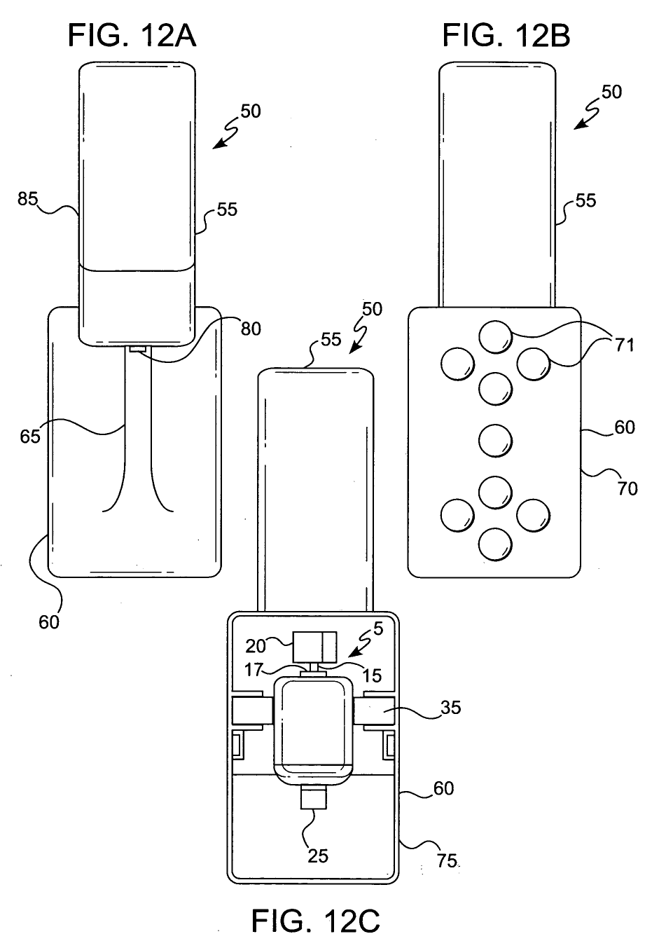

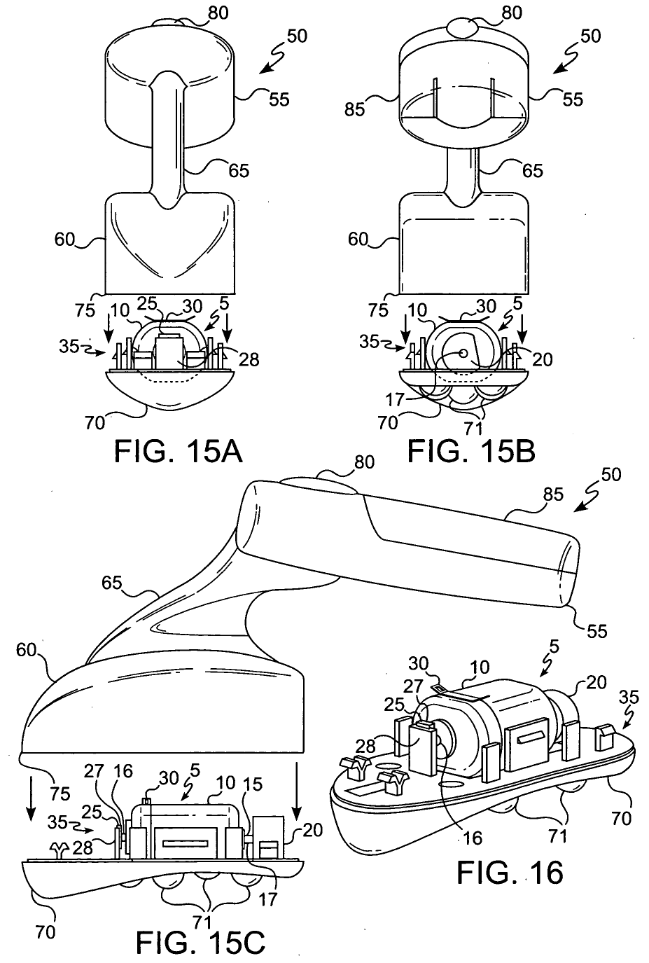

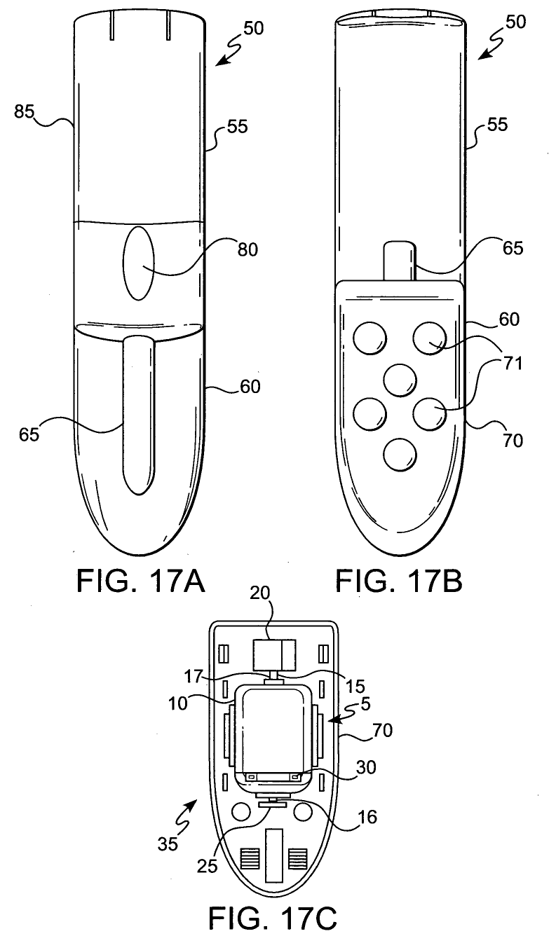

The motor (10) can be any standard motor presently on the market, including but not limited to DC and AC motors. In one preferred embodiment of the present invention, the motor (10) will be sufficiently small to fit within a handheld massage assembly (50) (shown in FIGS. 10-11C, 12C, 14-16, and 17C). It will be apparent to those in the art though, that the motor (10) may be of any size appropriate for the motor's intended use. The present invention encompasses motors (10) that may be used in a variety of settings, not just in massage assemblies (50). If the motor (10) is a standard DC or AC motor (10), it will likely have an electrical connection (30) on the motor (10) as shown in. FIGS. 1 through 4A and 5 through 8A. Additionally, the motor assembly (5) will require a power source such as, but not limited to, one or more batteries or a power cord to connect the motor assembly (5) to an electrical outlet.

The drive shaft (15) may be any type of drive shaft (15), regardless of whether the drive shaft (15) is sold together with or separate from a motor (10). The drive shaft (15) should be sized and composed of a material appropriate for its use with the motor (10) and the motor assembly (5). The drive shaft (15) should have a first end (16) and a second end (17). As shown in FIGS. 2A, 2B, 4A, 4B, 6A, 6B, 8A, and 8B, the drive shaft (15) should extend through the motor (10) with its (15) first (16) and second ends (17) extending beyond and on opposite sides of the motor (10).

As shown in FIGS. 1 through 3A, 4A through 7A, 8A, and 8B, a weight (20) is attached to the second end (17) of the drive shaft (15). The weight (20) may be secured to the drive shaft (15) using any appropriate means. The weight (20) may be of any size and mass. The weight (20) may be an eccentric weight (20). The larger and heavier the weight (20) used in the present invention, the stronger the vibrations created by the motor assembly (5). Thus, the size of the weight (20) may be chosen according to the strength of the vibrations desired. Similarly, the weight (20) may be made of any material appropriate for the motor assembly's (5) intended use. In a preferred embodiment of the present invention, the weight (20) would be of a size and mass sufficient to produce vibrations of a frequency of about thirty to sixty hertz (30-60 Hz). In some embodiments of the present invention, such a frequency for vibrations can be achieved by using a weight (20) of about ten grams (10 g).

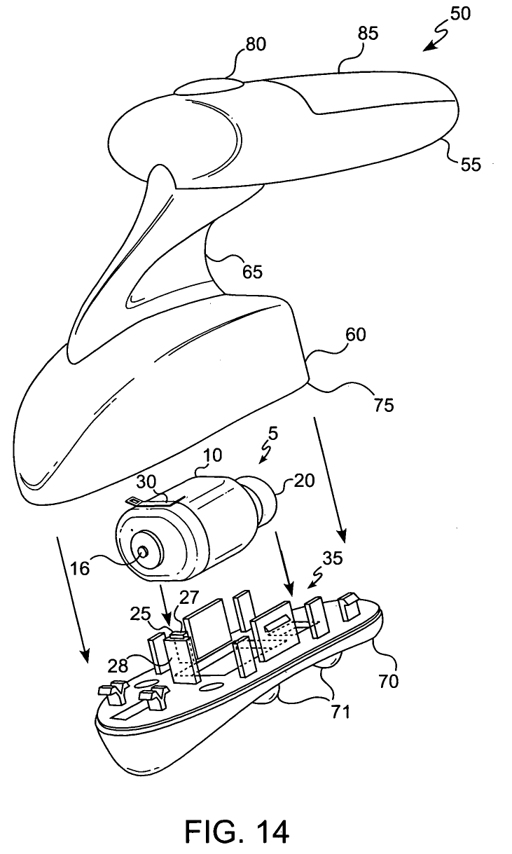

The novel pressure-applying member (25) may be any device that imparts pressure on the drive shaft (15) and, by doing so, stabilizes the motor assembly (5) resulting in less noise as the weight (20) rotates. One preferred embodiment of the present invention, shown in FIGS. 1 through 4B and 16, utilizes a folded piece of metal (27) secured by a post member (28) as the pressure-applying member (25). A portion of the folded piece of metal (27) applies pressure to the first end (16) of the drive shaft (15). The other end of the folded piece of metal (27) is secured to the motor assembly's (5) housing (35) by a post member (28), as shown in FIGS. 14, 15A, 15C, and 16. The folded piece of metal (27) can be secured directly to the housing (35) or it may be secured to an intermediate structure, such as an extension of the housing (35) or a post member (28) attached to the housing (35). In the preferred embodiment of the present invention, the pressure-applying member (25) should impart sufficient pressure on the drive shaft (15) so as to dampen some to all of the lateral motion of the drive shaft (15) and/or the motor assembly (5) while still allowing for the free movement of the drive shaft (15). In a preferred embodiment of the present invention, the pressure-applying member (25) may be any piece of material that is sufficiently bent and attached to the housing (35) so as to create a spring effect against the drive shaft (15).

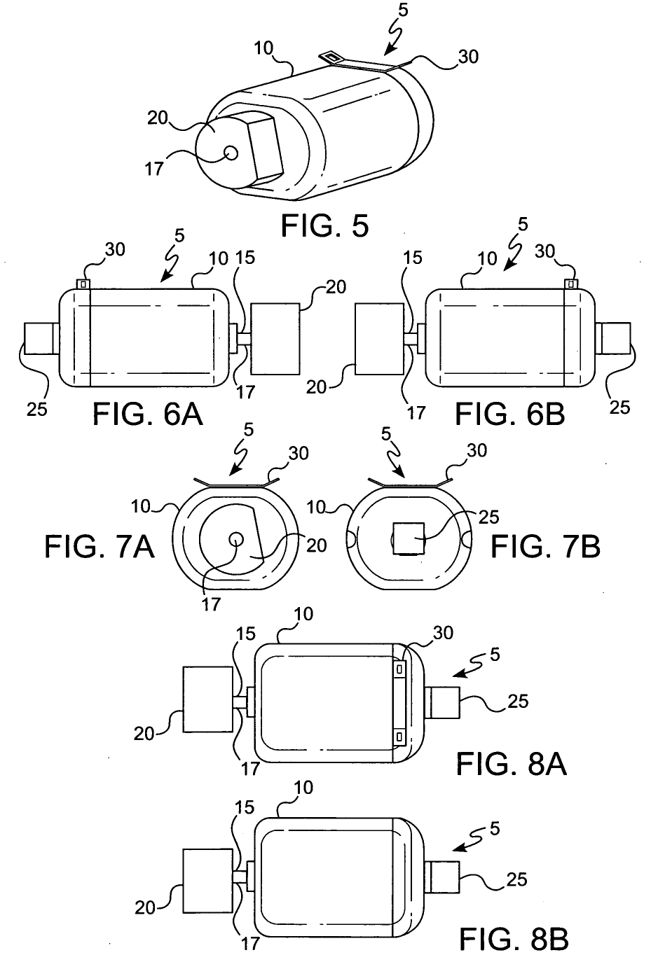

In another preferred embodiment of the present invention, shown in FIGS. 5 through 8B, the pressure-applying member (25) may be a piece of any of a variety of substances that is secured to the motor (10) and over the drive shaft's (15) first end (16), thus, applying pressure to the drive shaft's (15) first end (16). For example, the pressure-applying member (25) may be a piece of rubber or other similar shock-absorbing material, or it may be a material such as Teflon tape, tape, and/or foam. In this preferred embodiment of the present invention, the pressure-applying member (25) may be secured to the motor (10) by gluing, welding, or adhering in any of a variety of ways that will be obvious to those skilled in the art. Additionally, the pressure-applying member (25) for this embodiment may be any shape, size, mass, etc. that is appropriate for the motor (10), the weight (20), and for the user's preferences. It is also possible, although less preferable, to secure the pressure-applying member (25) to the first end (16) of the drive shaft (15) such that the pressure-applying member (25) abuts the motor (10) and puts pressure upon the first end (16) of the drive shaft (15).

One embodiment of the motor assembly (5) of the present invention may be secured to a housing (35), which consists of any structure designed to securely hold the motor assembly (5). The housing (35) is not an essential element of all embodiments the motor assembly (5) of the present invention. The housing (35) may be needed for some embodiments of the motor assembly (5) such as that shown in FIGS. 1 through 4B and 16 because the pressure-applying member (25) illustrated in those figures is designed to be secured to a housing (35) to provide pressure on the drive shaft (15).

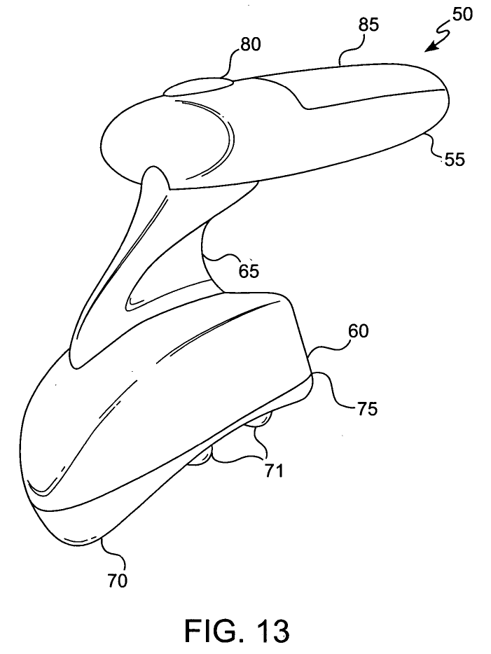

FIGS. 9 through 15C and 17A through 17C illustrate two embodiments of the present invention massage assembly (50), which comprise a handle unit (55) attached to a head unit (60) by a neck (65). Both embodiments shown in FIGS. 9 through 15C and 17A through 17C utilize a motor assembly (5) according to any of the embodiments, descriptions, and characteristics described previously for any motor assembly (5) according to the present invention. As shown in FIGS. 9 and 13, the embodiments differ in the shape of the head unit (60) and the handle unit (55) among other things.

As shown in FIGS. 9 through 17C, a massage assembly (50) according to the present invention has a head unit (60) having a face (70). The face (70) may separate from the head unit (60) and may attach/detach from the attachment side (75) of the head unit (60). According to the embodiments of the present invention shown in FIGS. 9 through 17C, protrusions (71) may extend from the face (70) of the head unit (60). Those protrusions (71) increase the sensation or stimulation created by the vibrating massage assembly (50). The protrusions (71) are not a necessary element of the present invention, but may be included according to the user's preference. The protrusions (71) may be of any size, shape, and number, again, according to the user's preferences.

The head unit (60) and the face (70) also may be of any size and shape. One embodiment of the present invention massage assembly (50) shown in FIGS. 9 through 12C has a rectangular head unit (60) with a rectangular flatter face (70) with protrusions (71) extending therefrom. Alternatively, a second embodiment of the present invention massage assembly (50), exemplified by FIGS. 13 through 17C, has an ergonomically designed head unit (60) and face (70). Such an ergonomically designed head unit (60) and face (70) may be designed to provide the maximum surface area between the face (70) of the massage assembly (50) and the body part of the user to which it is applied. It will be obvious to those skilled in the art that the head unit (60) and the face (70) may be of any size, shape, and contour according to the user's preference or the body part intended to be massaged by the massage assembly (50).

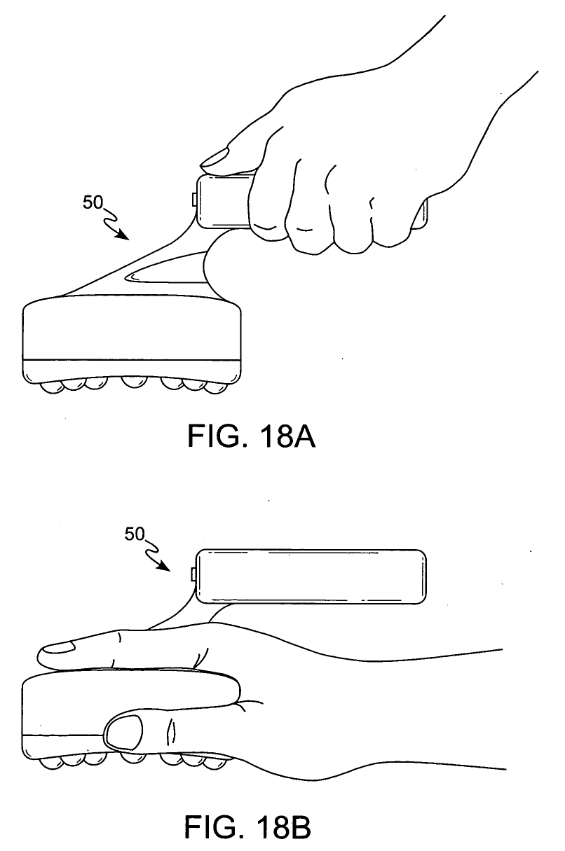

Similarly, the handle unit (55) may be of any size, shape, and dimensions according to the user's preference. The handle unit (55) shown in FIGS. 9 through 12C is depicted as more of a rectangular shaped handle unit (55) with soft, curved edges. The handle unit (55) shown in FIGS. 13 through 17C is a softer, more curved, more ergonomically correct version of that handle unit (55) shown in FIGS. 9 through 12C. In the preferred embodiment of the present invention, the handle unit (55) should be designed to fit comfortably within the palm of the user's hand, as shown in FIG. 18A.

Although not necessary, the handle unit (55) is an ideal place to house the power source, particularly batteries, for the massage assembly (50). If batteries are the chosen electrical supply for the massage assembly (50), they may be placed anywhere interior to or exterior to the massage assembly (50). If the batteries are to be housed in the handle unit (55), the handle unit (55) should be equipped with a battery cover (85). If the power source is a power cord, it can connect to any convenient point on the massage assembly (50).

A power button (80) should be located somewhere on the massage assembly (50). In the preferred embodiment of the present invention, the power button (80) is located on the handle unit (55). Such a location makes it convenient and easy for a user to turn the massage assembly (50) on and off with the hand that is holding the massage assembly (50). The power button (80) may be used to turn the massage assembly (50) on and off. Additionally, the power button (80) may be used to turn the massage assembly (50) to various vibratory levels such as low, high, and intermediate levels.

A neck (65) connects the head unit (60) and the handle unit (55). The neck (65) may be of any size, shape, or dimensions. The neck (65) is illustrated in the two embodiments shown in FIGS. 9 through 17C. In the preferred embodiment of the present invention, the neck (65) is designed to be ergonomically correct and comfortable in the hand of the user.

The two embodiments of the present invention massage assembly (50) shown in FIGS. 9A through 17C may be held by the user in a multitude of fashions. As shown in FIG. 18A, a user may hold the massage assembly (50) by grasping the handle unit (55) completely in the palm of the user's hand and wrapping his or her thumb and all four fingers around the handle unit (55). Alternatively, as shown in FIG. 18B, a user may hold the massage assembly (50) with the neck (65) between any two of the user's fingers, thus allowing the user's two fingers to rest on the top of the head unit (60). The back of the head unit (60) would then comfortably sit against the palm of the user's hand.

As detailed above, the present invention also comprises a process of decreasing the noise of any vibratory unit utilizing an electric motor assembly (5) by applying pressure to one end of the motor's (10) drive shaft (15). The application of such pressure to the motor's drive shaft (15) helps to stabilize the drive shaft (15) and the motor (10) while a weight (20), attached to the drive shaft's (15) other end, rotates.

1. An electric motor assembly for increasing vibratory power with less noise, said motor assembly comprising:
a motor;
a drive shaft having a first end and a second end, wherein said drive shaft runs through said motor and said drive shaft's first end exits on one side of said motor and said drive shaft's second end exits on the opposite side of said motor;
a weight secured to said drive shaft's second end; and
a pressure-applying member abutting and applying pressure to said drive shaft's first end.

2. The motor assembly of claim 1, wherein said weight is an eccentric weight.

3. The motor assembly of claim 1, wherein the weight is of a size and mass sufficient to produce vibrations of a frequency of about thirty to sixty hertz (30-60 Hz).

4. The motor assembly of claim 1, wherein the mass of the weight is about ten grams (10 g).

5. The motor assembly of claim 2, wherein said motor is selected from the group consisting of a DC motor and an AC motor.

6. The motor assembly of any one of claims 1 or 2, wherein said pressure-applying member comprises a piece of material secured to said motor assembly so as to apply pressure to said drive shaft's first end.

7. The motor assembly of claim 6, wherein said pressure-applying member is selected from the group consisting of a piece of rubber, Teflon tape, tape, and foam.

8. The motor assembly of any one of claims 1 or 2, also comprising:
a housing to which said motor assembly is secured.

9. The motor assembly of claim 8, wherein said pressure-applying member is secured to said housing and abuts said drive shaft's first end.

10. The motor assembly of claim 9 wherein said pressure-applying member comprises:
a piece of folded sheet metal; and
a post member secured to said housing that acts to secure one end of said piece of folded sheet metal such that said piece of folded sheet metal applies pressure to said drive shaft's first end.

11. The motor assembly of any one of claims 1 or 2, also comprising a power source.

12. The motor assembly of claim 1 1, wherein said power source is selected from the group consisting of at least one battery and a power cord.

13. The motor of claim 8 also comprising a power source.

14. The motor assembly of claim 13, wherein said power source is selected from the group consisting of at least one battery and a power cord.

15. A massage assembly comprising:
a handle unit;
a head unit;
a neck connecting said handle unit to said head unit;
a power source; and
an electric motor assembly for increasing vibratory power with less noise, said motor assembly comprising:
a motor;
a drive shaft having a first end and a second end, wherein said drive shaft runs through said motor and said drive shaft's first end exits on one side of said motor and said drive shaft's second end exits on the opposite side of said motor;
a weight secured to said drive shaft's second end; and
a pressure-applying member abutting and applying pressure to said drive shaft's first end.

16. The massage assembly of claim 15, wherein said weight is an eccentric weight.

17. The motor assembly of claim 15, wherein the weight is of a size and mass sufficient to produce vibrations of a frequency of about thirty to sixty hertz (30-60 Hz).

18. The motor assembly of claim 15, wherein the mass of the weight is about ten grams (10 g).

19. The massage assembly of claim 16, wherein said motor is selected from the group consisting of a DC motor and an AC motor.

20. The massage assembly of any one of claims 15 or 16, wherein said pressure-applying member comprises a piece of material secured to said motor assembly so as to apply pressure to said drive shaft's first end.

21. The massage assembly of claim 20, wherein said pressure-applying member is selected from the group consisting of a piece of rubber, Teflon tape, tape, and foam.

22. The massage assembly of any one of claims 15 or 16, also comprising:
a housing to which said motor assembly is secured.

23. The massage assembly of claim 22, wherein said pressure-applying member is secured to said housing and abuts said drive shaft's first end.

24. The massage assembly of claim 23, wherein said pressure-applying member comprises:
a piece of folded sheet metal; and
a post member secured to said housing that acts to secure one end of said piece of folded sheet metal such that said piece of folded sheet metal applies pressure to said drive shaft's first end.

25. The massage assembly of claim 15, wherein said power source is selected from the group consisting of at least one battery and a power cord.

26. A massage assembly comprising:
a handle unit;
a head unit having a face and an attachment side opposite said face;
a neck connecting said handle unit to the attachment side of said head unit;
a power source; and
an electric motor assembly for increasing vibratory power with less noise, said motor assembly comprising:
a motor, wherein said motor is selected from the group consisting of a DC motor and an AC motor;
a drive shaft having a first end and a second end, wherein said drive shaft runs through said motor and said drive shaft's first end exits on one side of said motor and said drive shaft's second end exits on the opposite side of said motor;
a weight secured to said drive shaft's second end, wherein said weight is an eccentric weight; and
a pressure-applying member abutting and applying pressure to said drive shaft's first end; and
wherein said motor assembly is secured within said head unit.

27. The massage assembly of claim 26, wherein the weight is of a size and mass sufficient to produce vibrations of a frequency of about thirty to sixty hertz (30-60 Hz).

28. The massage assembly of claim 26, wherein the mass of the weight is about ten grams (10 g).

29. The massage assembly of claim 26, wherein said pressure-applying member comprises a piece of material secured to said motor assembly so as to apply pressure to said drive shaft's first end.

30. The massage assembly of claim 29, wherein said pressure-applying member is selected from the group consisting of a piece of rubber, Teflon tape, tape, and foam that is secured to said motor.

31. The massage assembly of claim 26, wherein said pressure-applying member is secured to said housing and abuts said drive shaft's first end.

32. The massage assembly of claim 31, wherein said pressure-applying member comprises:
a piece of folded sheet metal; and
a post member secured to said housing that acts to secure one end of said piece of folded sheet metal such that said piece of folded sheet metal applies pressure to said drive shaft's first end.

33. The massage assembly of claim 26, wherein said power source is housed within said handle unit.

34. The massage assembly of claim 26, further comprising:
a power button to enable a user to turn said massage assembly on, off, and to various vibratory levels.

35. The massage assembly of claim 26, wherein said head unit is ergonomically shaped to conform to a person's body.

36. The massage assembly of claim 26, wherein a plurality of protrusions stem from said head unit's face.

37. The massage assembly of claim 26, wherein the back of said attachment side of said head unit is designed to ergonomically-and comfortably conform to the palm and fingers of a user.

38. The massage assembly of claim 26, wherein said neck is designed to ergonomically and comfortably rest between two adjacent fingers of a user.

39. The massage assembly of claim 26, wherein said handle unit is designed to ergonomically and comfortably fit in the palm of a user's hand.

40. A method of decreasing the noise of an electric motor in a vibratory unit, said method comprising the application of pressure to the end of said motor's internal drive shaft so as to decrease the lateral motion of said drive shaft and said motor while allowing said drive shaft to rotate.
